(19) United States
(12) Patent Application Publication
(10) Pub. No.: US 2020/0016692 A1
(43) Pub. Date: Jan. 16, 2020

(54) CALIBRATED LASER PRINTING METHOD

(71) Applicant: E&R Engineering Corp., Kaohsiung (TW)

(72) Inventors: Yu Min CHU, Kaohsiung (TW); Cho Chun CHUNG, Kaohsiung (TW); Tai Chih LIU, Kaohsiung (TW)

(73) Assignee: E&R Engineering Corp., Kaohsiung (TW)

(21) Appl. No.: 16/167,605

(22) Filed: Oct. 23, 2018

(30) Foreign Application Priority Data
Jul. 13, 2018 (TW) 107124244

(51) Int. Cl. B23K 26/04; B23K 26/082; G02B 26/08

(52) U.S. Cl. CPC B23K 26/04; G02B 26/0816; B23K 26/082

(57) ABSTRACT

The present disclosure relates to a calibrated laser printing method, which is a pre-laser machining operation of wafers and comprises steps as follows: a piece of calibration glass is carried and leveled by a leveling system; a plurality of target points are marked on the piece of calibration glass by a laser system based on data of default positions of the plurality of target points on the piece of calibration glass; true positions of the target points on the piece of calibration glass are measured by an image system; data of measured true positions is transmitted to a resetting system; the piece of calibration glass is shifted to a next location by a displacement system on which the leveling system is carried for repetitive executions of above steps in the case of measurement not completed; data between default and true positions of the target points is compared; a reflecting mirror is deflected by an angle for calibrations of laser beams projected on a wafer in the case of any offset between default and true positions of the target points out of specification.

### BACKGROUND OF THE INVENTION

### 1) Field of the Invention

The present disclosure relates to a calibrated laser printing method, particularly a pre-laser machining operation of wafers comprising steps as follows: a plurality of target points are marked on a piece of calibration glass by a laser system in a one-time process; true positions of the target points on the piece of calibration glass are measured by an image system; the piece of calibration glass is shifted to a next location by a displacement system on which the leveling system is carried for repetitive executions of previous steps and measurements of all target points by the image system; a reflecting mirror is deflected by an angle for calibrations of laser beams projected on a wafer based on data of default and true positions of the target points.

### 2) Description of the Prior Art

In general, some characters or digits should be marked on each die created on a wafer during the manufacturing process of semiconductor elements by a laser marker for recognition later.

In this regard, how to correct tolerances in laser beam machining draws more concerns because wafer-level marking and cutting to be completed within limited areas during mass production of wafers on which downsized and lightweight elements are manufactured is more precise.

There have been several patents for wafer machining as shown below.

As disclosed in Paten/Publication Number TW I608584 of the Intellectual Property Office, MOEA, R.O.C., apparatus and method for calibrating a marking position feature a thin film for position correction with which correct marking positions for characters/digits to be marked on a semiconductor die are measured and calibrated before a wafer-level marking process. The apparatus for calibrating a marking position on a wafer comprises: a support table on which a thin film for position correction is supported; a laser head from which laser beams are projected on the thin film for development of patterns; a visual camera with which data of pattern positions are collected; a mobile platform with which the support table is shifted horizontally; a control unit with which data between marking positions of patterns and default positions configured in the laser marker are compared and coincident.

As disclosed in Paten/Publication Number TW I577484 of the Intellectual Property Office, MOEA, R.O.C., three-dimensional laser processing apparatus comprises a laser source, a zoom lens unit, a galvo-scanning module, a visual module unit and a control unit: the laser source casts laser beams; the zoom lens unit and the galvo-scanning module are installed at the path of laser beam transmission; the visual module unit has a visual region; the control unit is electrically connected to and regulates the zoom lens unit as well as the galvo-scanning module such that laser beams are focused on multiple reference planes within a three-dimensional region correspondingly and the multiple positions of an image within the three-dimensional region are focused at the center of the visual region correspondingly through the zoom lens unit and an imaging lens unit of the visual module. Moreover, a positioning error correction method is disclosed in Paten/Publication Number TW I577484.

As disclosed in Paten/Publication Number CN 101412152A, a device for correcting laser processing comprises a control unit, a laser light source unit, a beam scanning unit and a light sensing unit. Moreover, a processing method also disclosed in CN 101412152A relies on the beam scanning unit to fully or partially scan a workpiece to be processed for generation of corresponding light signals at a scanning area in which the workpiece with different conditions is scanned. The light signals received by the light sensing unit are converted to state signals and transferred to the control unit in which the state signals are analyzed for acquisition of some attributes/status of the workpiece to be processed such as actual position, structure, material and thickness, determination of processing parameters to be calibrated such as processing positions and working conditions of the laser device based on status of the workpiece, and activation of processing steps according to corrected processing parameters.

The step of wafer calibration which is indispensable to long-drawn wafer manufacturing and limited to current technologies could be further optimized by corrected laser beam machining expectably for product demands and time efficiency. Accordingly, a calibrated laser printing method is disclosed hereinafter for conformance to requirements.

### SUMMARY OF THE INVENTION

In virtue of the above requirement, a calibrated laser printing method provided in the present disclosure is based on one-time laser beam machining supplemented by image detection subsequently for less calibration bias.

Accordingly, the present disclosure is to provide a calibrated laser printing method in which multiple calibrations of apparatus are completed through a piece of calibration glass for cost reduction of wafer machining.

The present disclosure is also to provide a calibrated laser printing method in which recalibrations are enabled for major offsets between default and true positions of target points in a specific region and more reduction of calibration cost.

To this end, the major technical measures herein refer to the following techniques. The present disclosure relates to a calibrated laser printing method which comprises following steps: (a) a piece of calibration glass is carried and leveled by a leveling system; (b) a plurality of target points are marked on the piece of calibration glass by a laser system based on data of default positions of the plurality of target points on the piece of calibration glass; (c) true positions of the target points on the piece of calibration glass are measured by an image system; (d) data of measured true positions is transmitted to a resetting system; (e) the piece of calibration glass is shifted to a next location by a displacement system on which the leveling system is carried for repetitive executions from (b) to (e); (f) data between default and true positions of the target points is compared; (g) a reflecting mirror is deflected by an angle for calibration of laser beams projected on a wafer in the case of any offset between default and true positions of the target points out of specification.

To this end, other technical measures also refer to the following techniques.

In the calibrated laser printing method, a piece of calibration glass is checked by the resetting system for availability and fetched from a storage box before step a.

In the calibrated laser printing method, surface features on the piece of calibration glass are recorded in the resetting system for defining data of default positions of the target points on the piece of calibration glass after step a.

In the calibrated laser printing method, the piece of calibration glass is exteriorly covered with a specific coated layer which can be removed by laser beams.

In the calibrated laser printing method, the laser system casts cross-hair reticles to mark the target points on the piece of calibration glass.

In the calibrated laser printing method, the reflecting mirror after step g is deflected by an angle for repetitive executions from step b to step g.

In the calibrated laser printing method, recalibrations at step b are enabled in a region in which some major offsets were detected.

Compared with the prior arts, a calibrated laser printing method herein is characteristic of effects as follows: (1) fast laser calibrations for cost reduction of wafer machining; (2) multiple calibrations available to apparatus through a piece of calibration glass for cost reduction of wafer machining; (3) recalibrations enabled in a region in which major offsets are detected for more reduction of calibration cost.

### BRIEF DESCRIPTIONS OF THE DRAWINGS

FIG. 1 is a schematic view of a calibration machine in a preferred embodiment.

FIG. 2a is a schematic view for a plurality of target points on a piece of calibration glass in a preferred embodiment.

FIG. 2b is a schematic view for regions on a piece of calibration glass in a preferred embodiment.

FIG. 2c is a schematic view for one region to be calibrated on a piece of calibration glass in a preferred embodiment.

FIG. 3 is a schematic view for a piece of calibration glass fetched from a storage box in a preferred embodiment.

FIG. 4 is a schematic view of a piece of calibration glass in a preferred embodiment.

FIG. 5 is the first flowchart of a calibrated laser printing method in a preferred embodiment.

FIG. 6 is the second flowchart of a calibrated laser printing method in a preferred embodiment.

FIG. 7 is the third flowchart of a calibrated laser printing method in a preferred embodiment.

### DETAILED DESCRIPTIONS OF THE PREFERRED EMBODIMENTS

A calibrated laser printing method is further illustrated in a first embodiment for clear understanding of purposes, characteristics and effects of the present disclosure.

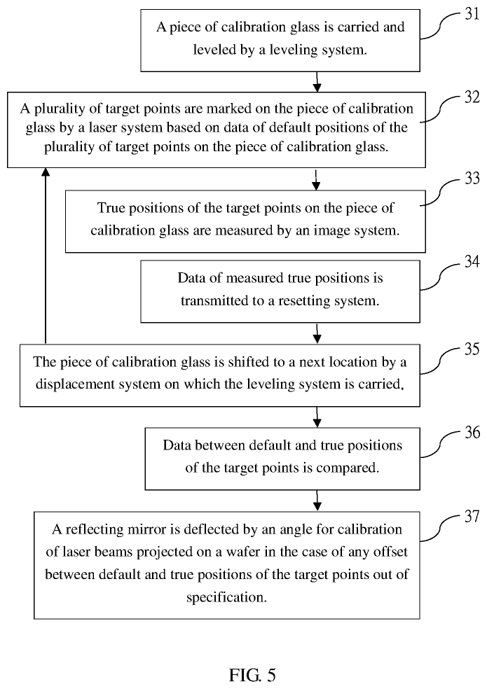

Referring to the flowchart in FIG. 5, which comprises step a (31), step b (32), step c (33), step d (34), step e (35), step f (36) and step g (37).

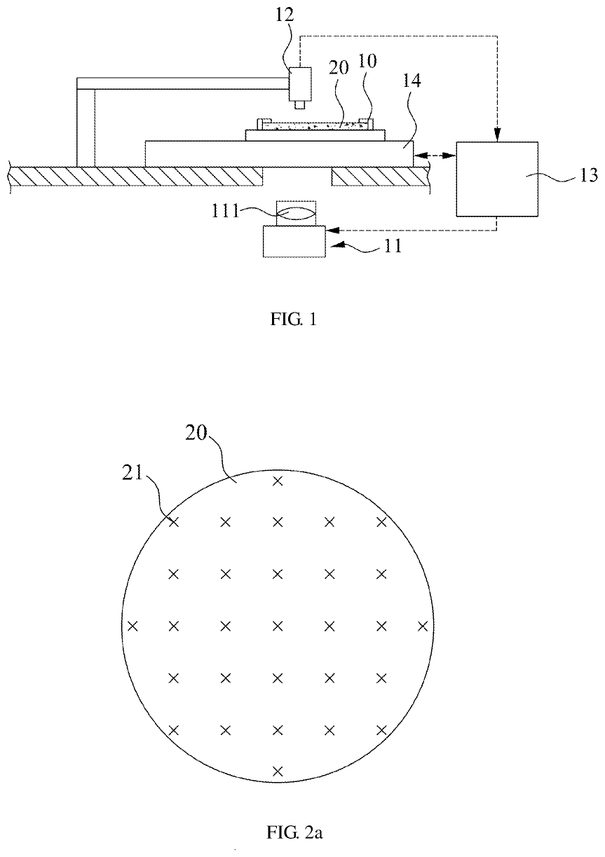

As shown in FIGS. 1 and 5, the step a (31) is to carry and level a piece of calibration glass (20) by means of a leveling system (10).

Specifically, the leveling system (10) is used to level a piece of calibration glass (20) carried in the leveling system (10) through vacuum absorption, jig fixing and magnetism fixing for less displacement and/or surface warping of an object carried inside and laser beam machining applied to the object later; moreover, the piece of calibration glass (20), which is a low-cost glass object applied in laser calibration before wafer production for correct positioning of laser beam machining on the piece of calibration glass (20), comprises a specific coated layer (201) exteriorly that can be erased by laser beams, as shown in FIG. 4.

Referring to FIGS. 1 and 5, the step b (32) is to mark a plurality of target points (21) on the piece of calibration glass (20) with a laser system (11) based on data for default positions of the plurality of target points (21) on the piece of calibration glass (20).

In general, some offsets of laser beam machining are clearly detected according to comparisons of data between default and true positions of the plurality of target points (21) uniformly marked on the surface of the calibration glass (20) for measurement and/or offset detection; moreover, the laser system (10), which is a LASER (Light Amplification by Stimulated Emission of Radiation) generation device generating excited light radiations and amplifying them to laser beams by “excitation source”, “gain medium” and “resonant structure” for applications far and wide, is applied in precision machining and semiconductor industries because of no machining stress but good accuracy and equipped with dust collectors around for collections of powders generated in a machining process.

Preferably, the laser system (11) casts cross-hair reticles to mark the target points (21) on the piece of calibration glass (20) for clear recognitions of the target points (21).

As shown in FIGS. 1 and 5, the step c (33) is to indicate an image system (12) with which the true positions of the target points (21) on the piece of calibration glass (20) are measured.

In general, the image system (12) is able to obtain true positions of the target points (21) by transferring image data to digital signals through CCD or CMOS photosensitive elements.

As shown in FIGS. 1 and 5, the step d (34) is to transmit data of measured true positions of the target points (21) to a resetting system (13).

Specifically, the resetting system (13) in which data related to the piece of calibration glass (20) as well as default and true positions of the target points (21) are stored has functions of data comparisons and laser parameter corrections.

As shown in FIGS. 1 and 5, the step e (35) is to shift the piece of calibration glass (20) to a next location by the displacement system (14) on which the leveling system (10) is carried for repetitive executions from step b (32) to step e (35).

In general, the displacement system (14) is an XY table with which the leveling system (10) is shifted along X and Y axes.

As shown in FIGS. 1 and 5, the step f (36) is to compare data of default and true positions of the target points (21).

In practice, the data of true positions of the target points (21) collected completely from step c (33) to step e (35) are compared with data of default positions of the target points (21).

Finally, as shown in FIGS. 1 and 5, the step g (37) is to deflect a reflecting mirror (111) by an angle and calibrate a location of laser beams projected on a wafer in the case of any offset between default and true positions of the target points (21) out of specification.

Specifically, the reflecting mirror (111) is a scanning galvo installed at the path of laser beam transmission and also a galvo-based mechanical scanner with a motor-driven physical mirror; the reflecting mirror (111) is connected with an electric motor's shaft mostly or the reflecting mirror (111) along with an electric motor is a stand-alone integrated unit in some designs probably.

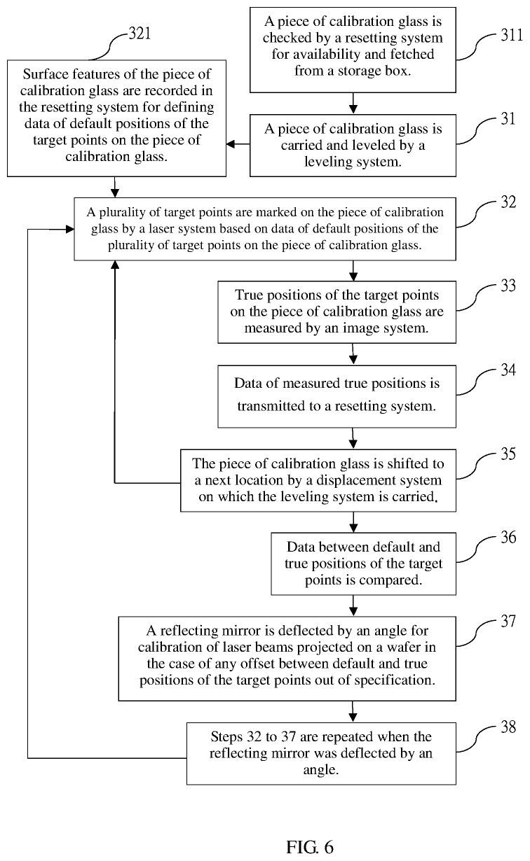

FIG. 6 illustrates a calibrated laser printing method in a second embodiment in which the symbols identical to those of the first embodiment in FIGS. 1 and 5 are not explained hereinafter. The differences in the second embodiment differing from the first embodiment are more steps such as step a0 (311), step b0 (321) and step h (38) in FIG. 6, compared with FIG. 5.

Referring to FIG. 6, which illustrates a flowchart with step a0 (311), step a (31), step b0 (321), step b (32), step c (33), step d (34), step e (35), step f (36), step g (37) and step h (38).

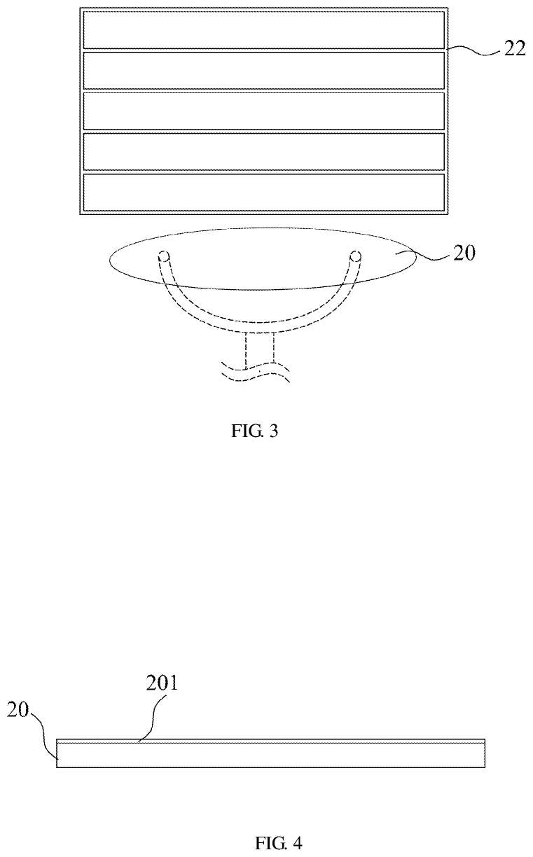

As shown in FIGS. 1, 3 and 6, step a0 (311) is to check availability of a piece of calibration glass (20) by the resetting system (13) before the piece of calibration glass (20) is unloaded from a storage box (22).

In the second embodiment, the resetting system (13) records service conditions of a piece of calibration glass (20) and the storage box (22) accommodates five pieces of calibration glass (20), each of which can be fetched by a robot.

As shown in FIGS. 1 and 6, a piece of calibration glass (20) caught by a robot is placed on and carried and leveled at the leveling system (10) in step a (31) after step a0 (311).

As shown in FIGS. 1 and 6, step b0 (321) is to record surface features of the piece of calibration glass (20) in the resetting system (13) for defining data of default positions of the target points (21) on the piece of calibration glass (20); accordingly, the piece of calibration glass (20) will be employed repeatedly until the piece of calibration glass (20) is unqualified.

Referring the step b (32) to the step g (37) hereinbefore. As shown in FIGS. 1 and 6, the step b (32) is to mark the target points (21) on the piece of calibration glass (20) by the laser system (11) based on data of default positions of the plurality of target points (21) on the piece of calibration glass (20); the step c (33) is to measure true positions of the target points (21) on the piece of calibration glass (20) by the image system (12); the step d (34) is to transmit data of the measured positions to the resetting system (13); the step e (35) is to shift the piece of calibration glass (20) to a next location by the displacement system (14) on which the leveling system (10) is carried for repetitive executions from the step b (32) to the step e (35); the step f (36) is to compare data between default and true positions of the target points (21); the step g (37) is to deflect the reflecting mirror (111) by an angle and calibrate a location of laser beams projected on a wafer in the case of any offset between default and true positions of the target points (21) out of specification.

Finally, step h (38) is to repeat the step b (32) to the step g (37) when the reflecting mirror (111) was deflected by an angle; moreover, step h (38) is to check whether laser beams adjusted are projected to an expected target.

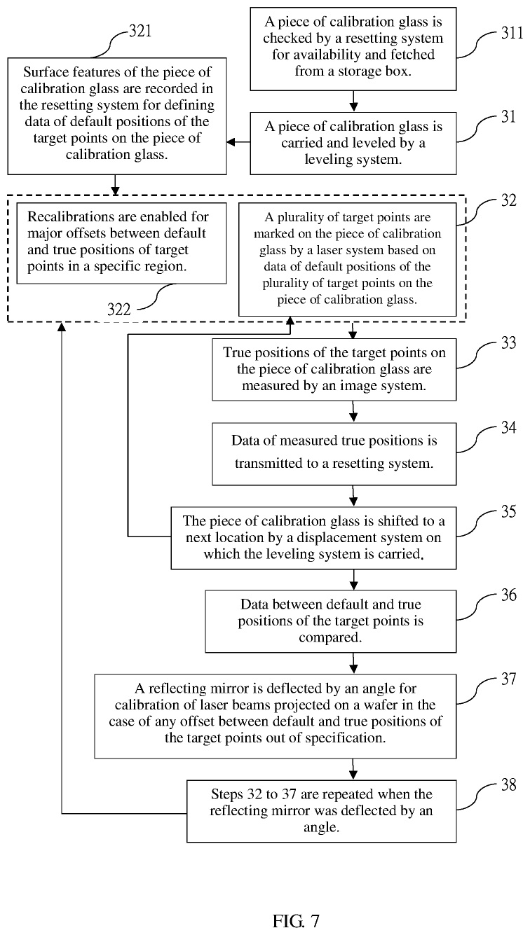

FIG. 7 illustrates a calibrated laser printing method in a third embodiment in which the symbols identical to those of the first and/or second embodiment in FIGS. 1, 5 and 6 are not explained hereinafter. The difference in the third embodiment differing from the first and/or second embodiment is an additional step of step b1 (322) in FIG. 7, compared with FIG. 6.

Referring to FIG. 7, which illustrates a flowchart with step a0 (311), step a (31), step b0 (321), step b1 (322), step b (32), step c (33), step d (34), step e (35), step f (36), step g (37) and step h (38).

In the third embodiment, most steps are identical to those in the second embodiment except step b1 (322). As shown in FIGS. 1 and 7, recalibrations in step b1 (322) are enabled in a region in which major offsets are detected.

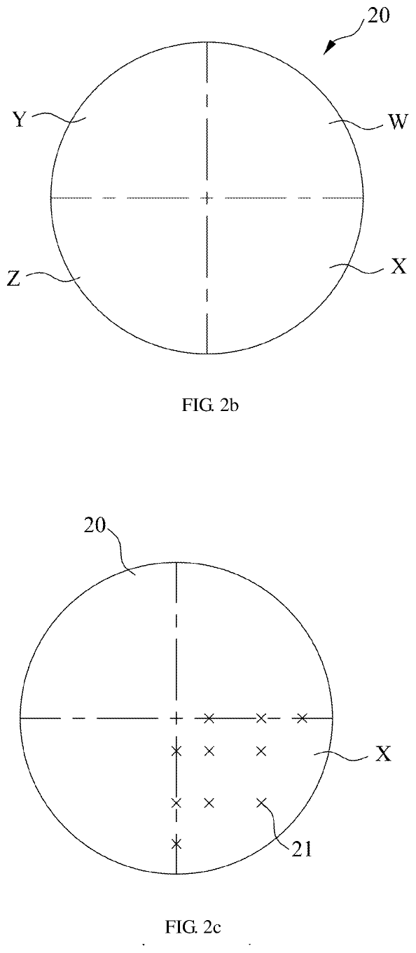

In practice, as shown in FIG. 2b, there are a first region (W), a second region (X), a third region (Y) and a fourth region (Z) virtually divided within an area to be machined. Referring to FIG. 7, which illustrates step b1 (322) is added with the step b (32) in the second embodiment enabled again after completion of the step h (38) for the first time. If there are some offsets between default and true positions of the target points (21) in the second region (X) out of specification only, the laser system is activated again to mark the target points in the second region (X) on the piece of calibration glass for least calibration time.

Accordingly, a calibrated laser printing method which differs from an ordinary calibration device and is referred to as creative work in the semiconductor industry meets patentability and is applied for the patent.

It should be reiterated that the above descriptions present the preferred embodiments, and any equivalent change in specifications, claims or drawings still belongs to the technical field within the present disclosure with reference to claims hereinafter.

What is claimed is:

1. A calibrated laser printing method, comprising steps as follows:
(a) a piece of calibration glass is carried and leveled by a leveling system;
(b) a plurality of target points are marked on the piece of calibration glass by a laser system based on data of default positions of the plurality of target points on the piece of calibration glass;
(c) true positions of the target points on the piece of calibration glass are measured by an image system;
(d) data of measured true positions is transmitted to a resetting system;
(e) the piece of calibration glass is shifted to a next location by a displacement system on which the leveling system is carried for repetitive executions from (b) to (e);
(f) data between default and true positions of the target points is compared;
(g) a reflecting mirror is deflected by an angle for calibrations of laser beams projected on a wafer in the case of any offset between default and true positions of the target points out of specification.

2. The calibrated laser printing method as claimed in claim 1 wherein a piece of calibration glass is checked by the resetting system for availability and fetched from a storage box before (a).

3. The calibrated laser printing method as claimed in claim 1 wherein surface features on the piece of calibration glass are recorded in the resetting system for defining data of default positions of the target points on the piece of calibration glass after (a).

4. The calibrated laser printing method as claimed in claim 1 wherein the piece of calibration glass is exteriorly covered with a specific coated layer which can be removed by laser beams.

5. The calibrated laser printing method as claimed in claim 1 wherein the laser system casts cross-hair reticles to mark the target points on the piece of calibration glass.

6. The calibrated laser printing method as claimed in claim 3 wherein the reflecting mirror after (g) is deflected by an angle for repetitive executions from (b) to (g).

7. The calibrated laser printing method as claimed in claim 3 wherein recalibrations at (b) are enabled in a region in which some major offsets were detected.
